(19) United States
(12) Patent Application Publication
(10) Pub. No.: US 2006/0035130 A1
(43) Pub. Date: Feb. 16, 2006

(54) Solid oxide fuel cell

(75) Inventors: Yasuo Noda, Nagoya-shi (JP); Shigenori Onuma, Toyota-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AISIN SEIKI KABUSHIKI KAISHA, Kariya-shi (JP)

(21) Appl. No.: 10/600,656

(22) Filed: Jun. 23, 2003

(30) Foreign Application Priority Data
Jun. 21, 2002 (JP) 2002-181681

(51) Int. Cl. H01M 8/10

(52) U.S. Cl. 429/33

(57) ABSTRACT

One embodiment of the present invention provides a solid oxide fuel cell, which includes: an anode; a cathode; and an ionically conducting solid oxide electrolyte disposed between the anode and the cathode; wherein the solid oxide electrolyte includes at least one first region having a relatively high operating temperature and at least one second region having a relatively low operating temperature; and wherein the composition of the solid oxide electrolyte is different in the first and second regions. Other embodiments of the invention provide methods for making and using the fuel cell, and also the solid oxide electrolyte.

### BACKGROUND OF THE INVENTION

This application is based on and claims priority to Japanese Patent Application No. 2002-181681 filed on Jun. 21, 2002, the entire contents of which are incorporated herein by reference.

### FIELD OF THE INVENTION

The present invention relates to a fuel cell system. More particularly, the present invention pertains to a solid oxide fuel cell system including a solid oxide system electrolyte.

### DISCUSSION OF THE BACKGROUND

Solid oxide fuel cell (SOFC) systems have advantages that the power generation is high and the electrode catalyst of precious metal system may be abolished or reduced because the SOFC system is operated at high temperature. As shown in FIG. 12, the SOFC system includes a solid oxide electrolyte 10 having the ion conduction, an anode 11 provided on a first side of the solid oxide electrolyte 10, a cathode 12 provided on a second side of the solid oxide electrolyte 10, a fuel supply passage 24 for supplying the fuel to the anode 11, and an air supply passage 26 for supplying the air serving as an oxidant to the cathode 12. The anode 11 and the cathode 12 are electrically connected via a conductor 13 and an external load 14. The solid oxide electrolyte 10 generally includes the oxygen ion conduction that the oxygen ion can pass through. More specifically, the solid oxide electrolyte 10 may include zirconia oxide and perovskite type lanthanum grade oxide, or the like including the oxygen ion conduction at the high temperature region (e.g., 800-1100° C.).

With the SOFC system, the fuel is supplied to the anode 11 and the oxidant (e.g., air) is supplied to the cathode 12. The air supplied to the cathode 12 generates the oxygen ion. The oxygen ion permeates the solid oxide electrolyte 10 to move to the anode 11 side. The oxygen ion at the anode 11 reacts with the fuel to generate water vapor or carbon dioxide. The fuel reacts with the generated water vapor and the carbon dioxide and the reform reaction is caused in the SOFC to generate the hydrogen and the carbon monoxide. The electron generated during the reaction moves to the cathode 12 via the conductor 13 and the external load 14.

With a SOFC system described in U.S. Pat. No. 6,033,794, a high temperature type SOFC and a low temperature type SOFC are provided individually. In this SOFC system, the high temperature type SOFC and the low temperature type SOFC are positioned in series to minimize the heat loss for facilitating the thermal design of the fuel cell.

A fuel cell described in Japanese Patent No. 3094099 (i.e., equivalent of Japanese Patent Laid-Open Publication No. 2000-268832) includes two-temperature-control connection type solid oxide fuel cell including a low temperature type SOFC whose operation temperature is low and a high temperature type SOFC whose operation temperature is high, which are individually arranged in series. With the fuel cell described in Japanese Patent No. 3094099, the lanthanum grade system electrolyte is applied as the solid oxide electrolyte for the low temperature SOFC and the yttria stabilized zirconia (YSZ) is applied as the solid oxide electrolyte for the high temperature type SOFC. An iron/yttria stabilized zirconia (Fe/YSZ) cermet is applied as the anode in the low temperature type SOFC. With the high temperature type SOFC, a nickel/yttria stabilized zirconia (Ni/YSZ) cermet is applied as the anode. According to the fuel cell described in Japanese Patent No. 3094099, provided that the Fe/YSZ cermet is applied as the anode when supplying the hydrocarbon system fuel to the anode, the approximately 200 hours durability is obtained even if carbon deposition is observed. On the other hand, when the total oxidation reaction is performed, the performance of the anode made with the Fe/YSZ cermet is inferior compared to the case in which the Ni/YSZ cermet is used. With the fuel cell described in Japanese Patent Laid-Open Publication No. 2000-268832, the composition of the solid oxide electrolyte is even for each cell. With this construction, the irregularity of the electric power generation due to the temperature distribution at each cell or the module cannot be sufficiently reduced.

A need thus exists for a solid oxide fuel cell system which achieves higher power generation efficiency.

### SUMMARY OF THE INVENTION

One embodiment of the present invention provides a solid oxide fuel cell, which includes:

an anode;

a cathode; and

an ionically conducting solid oxide electrolyte disposed between the anode and the cathode;

wherein the solid oxide electrolyte includes at least one first region having a relatively high operating temperature and at least one second region having a relatively low operating temperature;

and wherein the composition of the solid oxide electrolyte is different in the first and second regions.

Another embodiment of the present invention provides a method for making the above solid oxide fuel cell, which includes disposing the solid oxide electrolyte between the anode and the cathode.

Another embodiment of the present invention provides a fuel cell module, which includes one or more of the above solid oxide fuel cells;

at least one fuel supply passage configured to supply at least one fuel to the anode;

at least one oxidant supply passage configured to supply at least one oxidant to the cathode; and

at least one heating portion configured to heat the solid oxide electrolyte and generate a temperature gradient from the first and second regions.

Another embodiment of the present invention provides a method for producing electricity with the above solid oxide fuel cell, which includes contacting the anode with a fuel and contacting the cathode with an oxidant.

Another embodiment of the present invention provides an ionically conducting solid oxide electrolyte, which includes:

at least one first region having a relatively high operation temperature and at least one second region having a relatively low operation temperature;

and wherein the composition of the solid oxide electrolyte is different in the first and second regions.

Another embodiment of the present invention provides a method for making the above solid oxide electrolyte, which includes varying the composition of the solid oxide electrolyte between said first and second regions, to form the ionically conducting solid oxide electrolyte.

### BRIEF DESCRIPTION OF THE FIGURES

The foregoing and additional features and characteristics of the present invention will become more apparent from the following detailed description considered with reference to the accompanying drawing figures in which like reference numerals designate like elements.

FIG. 1 is a perspective view of a cylindrical cell according to a first embodiment of the present invention.

FIG. 2 is a perspective view of a cylindrical solid oxide electrolyte according to the first embodiment of the present invention.

FIG. 3 is a cross-sectional view of a solid oxide type fuel cell system according to the first embodiment of the present invention.

FIG. 4 is a view showing a calculation example when using the solid oxide electrolyte according to the first embodiment of the present invention.

FIG. 5 is a view showing a calculation example when using a solid oxide electrolyte according to a comparison example.

FIG. 6a is a cross sectional view of a cell sandwiching a plate solid oxide electrolyte with an anode and a cathode.

FIG. 6b is a plan view of the plate solid oxide electrolyte.

FIG. 7a is a cross sectional view of a cell sandwiching a plate solid oxide electrolyte with an anode and a cathode.

FIG. 7b is a plan view of the plate solid oxide electrolyte.

FIG. 8 is a perspective view of a solid oxide fuel cell according to a second embodiment of the present invention.

FIG. 9 is a perspective view of a solid oxide fuel cell according to a third embodiment of the present invention.

FIG. 10 is a cross-sectional view of a main portion of the solid oxide fuel cell according to the third embodiment.

FIG. 11 is a cross-sectional view of a main portion of a solid oxide fuel cell according to a fourth embodiment.

FIG. 12 is a view showing a prior art configuration.

### DETAILED DESCRIPTION OF THE INVENTION

Embodiments of the present invention will be explained with reference to drawing figures, which embodiments are not intended to be limiting.

With embodiments of the solid oxide fuel cell system including a single cell or including a cell module having plural cells assembled, the solid oxide electrolyte is determined to include different compositions at high temperature region whose operation temperature is relatively high and at low temperature region whose operation temperature is relatively low. By providing different compositions at the high temperature region and at the low temperature region, it is not only possible to achieve favorable power density at the high temperature region of the solid oxide electrolyte, but it is also possible to obtain a favorable power density at the low temperature region. In other words, the composition which achieves high ion conduction at the high temperature region is adopted at the high temperature region of the solid oxide electrolyte. In addition, the composition which achieves high ion conduction at the low temperature region is adopted at the low temperature region of the solid oxide electrolyte. Thus, favorable power generation is achieved at both high temperature region and at the low temperature region of the solid oxide electrolyte, which improves the power generation efficiency.

The solid oxide fuel cell system preferably includes a heating portion configured to heat the solid oxide electrolyte. The heating portion is configured to form a thermal gradient including the relatively low temperature region and the relatively high temperature region on the solid oxide electrolyte of either the single cell or the cell module including plural single cells. In this case, the low temperature region corresponds to the region of the solid oxide electrolyte having relatively low operation temperature compared to a portion of the high temperature region. On the other hand, the high temperature region corresponds to the region of the solid oxide electrolyte having relatively high operation temperature compared to a portion of the low temperature region.

Preferably, either a combustion portion for burning off gas or an electric resistance heating portion for energizing and heating the solid oxide electrolyte or both may serve as the heating portion. The solid oxide electrolyte may be configured to have a graded composition from the low temperature region having relatively low temperature, to an intermediate temperature region having relatively intermediate temperature, and to the high temperature region having relatively high temperature.

The hydrocarbon system gas may be applied as the fuel supplied to the anode. Suitable gases include, for example, methane, ethane, propane, butane, ethylene, propylene, either alone or in mixture of any one of them. In addition, gasoline after desulphurization and kerosene may be adopted. The oxygen-bearing gas such as the air may be suitably applied as the oxidant supplied to the cathode.

Although the high temperature and low temperature of the operation temperature are determined relatively, the low temperature region may be determined to be equal to or greater than 500° C. and less than 700° C., the intermediate temperature region may be determined to be equal to or greater than 700° C. and less than 900° C., and the high temperature region may be determined to be equal to or greater than 900° C. and less than 1100° C. These ranges respectively include 500, 550, 600, 650, 700, 750, 800, 850, 900, 950, 1000, 1050, and 1100° C. as appropriate.

A sealing portion configured to seal the solid oxide electrolyte may be provided to the fuel cell in order to restrain the leak of at least one of the fuel and the oxidant (the oxygen-bearing material such as air). In this case, the sealing portion may seal the low temperature region of the solid oxide electrolyte with relatively low temperature. By providing the sealing portion on the low temperature region of the solid oxide electrolyte, the heat resistance condition required for the sealing portion is mitigated, the heat deterioration of the sealing portion is restrained, the life of the sealing portion is extended, and the degree of freedom for selecting the material of the sealing portion is increased. The glass system, ceramic system, carbon system, metal system, or cermet system which is the mixture of metal and ceramic may be used to make the sealing portion.

The solid oxide electrolyte includes a composition region including lanthanum oxide as base material and one or more of lanthanum (La), strontium (Sr), gallium (Ga), and/or magnesium (Mg), and A element (A element corresponds to at least one of cobalt (Co), nickel (Ni) or both). The solid oxide electrolyte may include the electrolyte configured to increase the magnesium with mole ratio and to decrease the A element as the operation temperature is changed according to the composition region from the low temperature region with relatively low temperature to the high temperature region with relatively high temperature via the intermediate temperature region. In the high temperature region, the A element may be reduced to be zero mole.

Perovskite type lanthanum oxide may be adopted as the solid oxide electrolyte. Preferably, lanthanum oxide including lanthanum (La), strontium (Sr), gallium (Ga), and/or magnesium (Mg), and A element (A element corresponds to at least one of cobalt (Co), nickel (Ni) or both) may be applied as base material. For example, the oxide having the following composition formula (e.g., Z=0-0.2) may be adopted as the lanthanum oxide: La_{0.8}Sr_{0.2}Ga_{0.8}Mg_{0.2-X}A_{X}O_{3-Z}. The oxide including the following composition formula (Z=0-0.20) may be adopted: La_{0.9}Sr_{0.1}Ga_{0.8}Mg_{0.2-X}A_{X}O_{3-Z}.

Z in the formulas above may be 0, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.20 as appropriate.

With the foregoing composition formulas, A element may correspond to at least one of cobalt (Co), nickel (Ni) or both. With the foregoing composition formulas, X is varied within the range of between 0.08-0 (i.e., X=0.08-0). Accordingly, the graded composition gradually reducing the value of X in the composition formula as moving to the portion increasing the operation temperature in the solid oxide electrolyte is determined. In the high temperature region, X is determined to be zero (X=0) in the composition formula so that the A element is not included in the high temperature region.

X in the formula above may be 0, 0.01, 0.02, 0.03, 0.04, 0.05, 0.06, 0.07, and 0.08.

The graded composition may include the composition that the included element is consecutively varied or may include the composition that generates the same effect with the graded composition as a whole although the plural cells are arranged in series and each cell includes different elements.

The solid oxide electrolyte may include an electrolyte portion including ceria oxide as a base material. Ceria oxide having the following composition formula (e.g., δ=0-0.4) may be adopted; Ce_{0.8}B_{0.2}O_{1.9-δ}. In the foregoing composition formula, B element may include at least one of samarium (Sm), gadolinium (Gd) or both. Because ceria oxide is likely to increase the electronic conduction component at the high temperature, the ceria oxide is preferably not be adopted for the high temperature region with relatively high temperature (e.g., 900-1100° C.) although it is preferably used for the low temperature region having relatively low temperature (e.g., 500-700° C.). Accordingly, in the intermediate temperature region and the high temperature region, stabilized zirconia which is stabilized with at least one of yttria and scandia is 5 adopted. More particularly, in the high temperature region, yttria stabilized zirconia stabilized by yttria may be adopted because the high ion conduction can be obtained in the high temperature region.

The solid oxide electrolyte may include the electrolyte portion (relatively high temperature region) whose base material is zirconia oxide. As zirconia oxide, scandia stabilized zirconia, yttria stabilized zirconia, and the mixture thereof may be applied. Accordingly, the solid oxide electrolyte may adopt the electrolyte portion having the composition region including the oxide whose main element is zirconia stabilized by the mixture of yttria and scandia. In this case, as moving to the portion increasing the operation temperature in the composition region, yttrium (Y) may be relatively increased by mole ratio and scandium (Sc) may be relatively reduced.

As the stabilized zirconia, the oxide having the following composition formula (e.g., Z=0-0.4) is preferably adopted: Zr_{0.8}Sc_{0.2-X}Y_{X}O_{1.9-Z}. X is varied within the range between zero to 0.2 (X=0-0.2). Z in the formula above may be 0, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, and 0.4 as appropriate. X in the formula above may be 0, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, and 0.2 as appropriate. Thus, the graded composition that the value of X is relatively increased within the range between zero to 0.2 as moving to the portion increasing the operation temperature. In this case, the composition having the yttria stabilized zirconia as a base material may be adopted in the high temperature region (e.g., 900-11100° C.) because the high ion conductance can be obtained in the high temperature region. Even composition rather than the graded composition is applied to the high temperature region. Because the diffusion degree is greater in the high temperature region than the diffusion degree in the low temperature region, the influence by the diffusion of the element can be restrained. Because the mole percent of yttria and scandia exists in the range of 7-11 percent in the stabilized zirconia, the ratio of Zr can be slightly increased in the composition of the stabilized zirconia. And thus the composition range from Zr_{0.8}Sc_{0.2-X}Y_{X}O_{1.9-Z} to Zr_{0.87}Sc_{0.13-X}Y_{X}O_{1.9-Z} is achieved. In case of the composition Zr_{0.87}Sc_{0.13-X}Y_{X}O_{1.9-Z}, generally Z may be determined to be zero to 0.4 and X may be determined to be zero to 0.13 (Z=0-0.4, X=0-0.13). Z in the formulas above may be 0, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, and 0.4 as appropriate. X in the formulas above may be 0, 0.01, 0.02, 0.03, 0.04, 0.05, 0.06, 0.07, 0.08, 0.09, 0.1, 0.11, 0.12 and 0.13 as appropriate.

The low temperature region of the solid oxide electrolyte includes ceria oxide mainly including cerium (Ce) and B element (i.e., B element includes at least one of samarium (Sm), gadolinium (Gd) or both). The intermediate temperature region of the solid oxide electrolyte includes base material of stabilized zirconia oxide such as scandia stabilized zirconia or yttria stabilized zirconia or the like. The high temperature region (greater than 900° C.) of the solid oxide electrolyte includes base material of stabilized zirconia oxide such as yttria stabilized zirconia system or the like.

The variation of the composition of the solid oxide electrolyte depending on the portion may be achieved according to the following methods. Before sintering the solid oxide electrolyte, a compressed green compact is formed by charging some ratio of the mixed powder which varies depending on the portion of the solid oxide electrolyte in a formation cavity. Thereafter, the solid oxide electrolyte is formed by sintering the green compact.

The solid oxide electrolyte may be formed by impregnating the surface of the green compact with the solution including the composition element before sintering the solid oxide electrolyte. In this case, the green compact is formed by compressing the mixed powder. Thereafter, the solid oxide electrolyte is formed by sintering the green compact. In this case, by varying the impregnation ratio in accordance with the portion of the green compact, the composition can be varied in accordance with the portion of the solid oxide electrolyte. The solid oxide electrolyte may be formed by using a sheet such as paper impregnated with the solution including the composition element to be the solid oxide electrolyte. By sintering the sheet, the solid oxide electrolyte may be formed. With the sheet, the concentration gradient of the composition element impregnated on the sheet is provided.

A preferred cell according to a first composition embodiment will be explained as follows. The cylindrical cell of the solid oxide fuel cell includes a cylindrical solid oxide electrolyte having the ion conduction, a cylindrical porous anode provided on one side of the solid oxide electrolyte in thickness direction, and a cylindrical porous cathode provided on the other side of the solid oxide electrolyte in the thickness direction.

A high temperature region T3 having high operation temperature (e.g., 900-1100° C.) is formed on the solid oxide electrolyte. A low temperature region Ti having the low operation temperature (e.g., 500-700° C.) is formed on the solid oxide electrolyte. An intermediate temperature region T2 (e.g., 700-900° C.) is determined between the high temperature region T3 and the low temperature region T1 on the solid oxide electrolyte.

It is preferable that the solid oxide electrolyte exhibits high oxygen ion conduction at each operation temperature. Further, it is preferable that the solid oxide electrolyte exhibits low electronic conduction in order to reduce the Joule heat. With the single cell, the solid oxide electrolyte includes an electrolyte portion with the integral construction having different compositions in accordance with the temperature gradient of the operation temperature. It is for increasing the ion conduction of each portion of the solid oxide electrolyte even when the solid oxide electrolyte includes the temperature gradient of the operation temperature. As a result, the solid oxide electrolyte includes a composition at the high temperature region having relatively high operation temperature and a composition at the low temperature region having relatively low temperature which is different from each other.

In other words, the low temperature region T1 and the intermediate temperature region T2 of the single solid oxide electrolyte is formed including the perovskite type lanthanum oxide (oxide of LaGaO₃ type) which exhibits the favorable ion conduction even at the low temperature. Particularly, the solid oxide electrolyte is formed with lanthanum oxide having the base material and one or more of lanthanum (La), strontium (Sr), gallium (Ga), and/or magnesium (Mg), and A element in the low temperature region Ti and the intermediate temperature region T2. More particularly, in the low temperature region T1 and the intermediate temperature region T2, the solid oxide electrolyte is formed including the lanthanum oxide having the composition formula La_{0.8}Sr_{0.2}Ga_{0.8}Mg_{0.2-X}A_{X}O_{3-Z} (e.g., Z=0-0.2). The numeral in the foregoing composition formula shows the mole ratio. In the foregoing composition formula, A element is at least one of cobalt (CO), nickel (Ni), or both.

In other words, in the low temperature region T1 of the lanthanum system solid oxide electrolyte, the value of X is gradually reduced to have graded composition from 0.08 to 0.04 as moving to the portion increasing the operation temperature.

X in the formula above at the low temperature region T1 may be 0.04, 0.045, 0.05, 0.055, 0.06, 0.065, 0.07, 0.075, and 0.08 as appropriate. Z in the formula above may be 0, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, and 0.2 as appropriate.

In the intermediate temperature T2 of the solid oxide electrolyte, the value of X is gradually reduced from 0.04 to zero to have the graded composition in the foregoing composition formula as the operation temperature increases so that the high ion conduction at the intermediate temperature region is obtained and the electronic conduction component is reduced (X=0.04→X=0). When X is zero, the oxide of the following composition formula is obtained: La_{0.8}Sr_{0.2}Ga_{0.8}Mg_{0.2}O_{3-Z} (e.g., Z=0-0.2).

X in the formula above at the intermediate temperature T2 may be 0, 0.01, 0.015, 0.02, 0.025, 0.03, 0.035, and 0.04 as appropriate. Z in the formula above at the intermediate temperature T2 may be 0, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, and 0.2 as appropriate.

According to the first preferred composition embodiment, X is determined as zero (X=0) in the foregoing composition formula in the high temperature region T3 (900-1100° C.) according to a single solid oxide electrolyte. In other words, the composition is determined as La_{0.8}Sr_{0.2}Ga_{0.8}Mg_{0.2}O_{3-Z} (e.g., Z=0-0.2) to have the even composition. The high temperature region T3 according to the solid oxide electrolyte is determined to have the even composition not the graded composition. The reason why the even composition is applied to the high temperature region T3 is believed to be as follows. Because of the high temperature of the high temperature region T3, reciprocal diffusion of the element constructing the solid oxide electrolyte becomes too large to be ignored and the composition variation in accordance with the high temperature maintaining time becomes too large to be ignored when the graded composition is applied. Thus, the graded composition is not applied to the high temperature region T3 and X is determined to be zero (X=0). Also, the even composition which is not added with cobalt and nickel corresponding to the A element is applied: La_{0.8}Sr_{0.2}Ga_{0.8}Mg_{0.2}O_{3-Z} (e.g., Z=0-0.2).

Z in the formula above at the high temperature region T3 may be 0, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, and 0.2 as appropriate.

An anode is supplied with the fuel gas, electrochemically oxidizes the fuel gas, and generates the electron. Considering the function of the anode, the anode includes cermet formed by mixing nickel as metal phase and ceria oxide as ceramic phase in the low temperature region T1 and the intermediate temperature region T2. Nickel is included in order to obtain catalytic activity relative to the fuel gas.

The anode of the first composition embodiment will be further explained as follows. As indicated above, the anode includes cermet in which nickel and ceria oxide is mixed. Thus, in the low temperature region T1, the anode includes the cermet having the composition formula of Ni—Ce_{1-X}B_{X}O_{1.9-δ} (e.g., δ=0-0.40). In this composition formula, B element corresponds to one or more of samarium (Sm), gadolinium (Gd), yttrium (Y), and lanthanum (La). In this case, with the foregoing composition formula, the value of X can be gradually reduced from 0.3 (e.g., approximately 500° C.) to 0.2 (e.g., approximately 700° C.) as moving to the portion increasing the operation temperature of the solid oxide electrolyte (i.e., within the range X=0.3-0.2).

X in the formula above at the low temperature region T1 may be 0.2, 0.21, 0.22, 0.23, 0.24, 0.25, 0.26, 0.27, 0.28, 0.29, and 0.3 as appropriate. δ in the formula above may be 0, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, and 0.4 as appropriate.

In the intermediate region temperature T2, the anode includes the mixed material including the cermet shown as the foregoing composition formula having X being equal to 0.2 (X=0.2) and Ni—YSZ cermet (i.e., Ni—Ce_{0.8}B_{0.2}O_{1.9-δ}. In this case, δ is determined, for example, to be zero to 0.40 (δ=0-0.40). This composition is determined considering the electronic conduction in the intermediate temperature region T2. As explained above, B element includes one or more of samarium (Sm), gadolinium (Gd), yttrium (Y), and lanthanum (La). In this case, Ni—YSZ cermet corresponds to the cermet in which nickel phase and YSZ phase are mixed. With the intermediate temperature region T2 of the anode, the graded composition increasing the ratio of the dimension of the Ni—YSZ cermet as moving to the portion having the higher operation temperature is applied. It is for dealing with the thermal gradient.

In the high temperature region T3, the anode includes the cermet in which Ni as the metal phase and yttria stabilized zirconia as ceramic phase considering the ion conduction, the electronic conduction, and the reduction of the element diffusion in the high temperature region T3.

A cathode is supplied with the air preferably serving as the oxygen bearing material functioning as oxide, serves as a place for a reaction between the oxygen and the electron, and serves as the conduction passage for supplying the electron from the external load to the reaction place. Thus, it is required that the cathode reduces the oxygen to oxygen ion, exhibits high electronic conduction, and exhibits high ion conduction. The cathode having this function includes the oxide shown with the composition formula of B_{0.6}Sr_{0.4}MnO_{3-δ} (e.g., δ=0-0.25) such as manganese oxide for applying to the low temperature region T1. The foregoing composition is applied to the low temperature region T1 for achieving high electronic conduction on the low temperature region T1. δ in the formula above may be 0, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, and 0.25 as appropriate. In this composition formula, at least part of Sr can be replaced with Ca. At least part of Mn can be replaced with Co. In this composition formula, B element corresponds to one or two or more than two kinds of samarium (Sm), gadolinium (Gd), yttrium (Y), and lanthanum (La). Thus, the composition formula may be La_{0.6}Sr(or Ca)_{0.4}MnO_{3-δ} (δ=0-0.2). δ in the formula above may be 0, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, and 0.2 as appropriate.

The cathode according to the first composition embodiment includes two layered construction including an internal layer on the solid oxide electrolyte and an external layer on the air layer side on the intermediate temperature region T2. The internal layer is formed with the ceria-zirconia oxide shown as (Ce_{1-X}Zr_{X})_{0.8}B_{0.2}O_{1.91-δ} (e.g., δ=0-0.41). δ in the formula above may be 0, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, 0.4, and 0.41 as appropriate. As being closer to the portion with higher operation temperature, the value of X is increased from zero to 0.5 to be approximate to 0.5. In this composition formula, as foregoing, B element corresponds to one or two or more than two kinds of samarium (Sm), gadolinium (Gd), yttrium (Y), and lanthanum (La). The external layer includes the oxide shown with the composition formula of B_{0.6}Sr_{0.4}MnO_{3-δ} (generally, δ=0-0.25). δ in the formula above may be 0, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, and 0.25 as appropriate. In this composition formula, B element corresponds to one or more of samarium (Sm), gadolinium (Gd), yttrium (Y), and lanthanum (La). In this composition formula, at least part of Sr can be replaced with Ca and at least part of Mn can be replaced with Co.

X in the formula above at the intermediate temperature region T2 may be 0, 0.05, 0.1, 0.15, 0.2, 0.25, 0.3, 0.35, 0.4, 0.45, and 0.5 as appropriate.

In the high temperature region T3, the cathode includes layered construction including an internal layer on the solid oxide electrolyte side and the external layer on the air side. The internal layer on the solid oxide electrolyte side includes ceria-zirconia oxide shown as (Ce_{1-X}Zr_{X})_{0.8}B_{0.2}O_{1.91-δ} (e.g., δ=0-0.41). As being closer to the portion with higher operation temperature, the value of X is increased from zero to 0.5 to be approximate to 0.5. In this composition formula, as foregoing, B element corresponds to one or two or more than two kinds of samarium (Sm), gadolinium (Gd), yttrium (Y), and lanthanum (La).

X in the formula above at the high temperature region T3 may be 0, 0.05, 0.1, 0.15, 0.2, 0.25, 0.3, 0.35, 0.4, 0.45, and 0.5 as appropriate. δ in the formula above may be 0, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, 0.4, and 0.41 as appropriate.

The external layer includes the oxide shown with the composition formula of B_{0.6}Sr_{0.4}MnO_{3-δ} (generally, δ=0-0.25). In this composition formula, B element corresponds to one or more of samarium (Sm), gadolinium (Gd), yttrium (Y), and lanthanum (La). In this composition formula, at least part of Sr can be replaced with Ca and at least part of Mn can be replaced with Co. δ in the formula above may be 0, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, and 0.25 as appropriate.

The low temperature region T1 of the inter-connector includes metal system because severe thermal resistance is not required. In other words, the low temperature region T1 of the inter-connector includes stainless alloy including iron-nickel-chrome as a base material. The intermediate temperature region T2 of the inter-connector includes cermet in which metal phase and ceramic phase are mixed considering the electronic conduction and thermal resistance. The metal phase may correspond to stainless alloy including iron-nickel-chrome. The oxide of lanthanum chromite (LaCrO₃) system may be used as the ceramic phase. Preferably, the oxide shown with the composition formula of La_{0.8}Sr (or Ca)_{0.2}CrO_{3-Z} (e.g., Z=0-0.1) is applied. In this embodiment, “or” means that the element indicated following “or” is replaceable with the element indicated previous to “or.”

Z in the formula above may be 0, 0.01, 0.02, 0.03, 0.04, 0.05, 0.06, 0.07, 0.08, 0.09, and 0.1 as appropriate.

The high temperature region T3 of the inter-connector includes the oxide of lanthanum chromite (LaCrO₃) having perovskite construction as the base material considering the electronic conduction and the thermal resistance. More particularly, the high temperature region T3 of the inter-connector includes the oxide shown with the composition formula of La_{0.8}Sr (or Ca)_{0.2}CrO_{3-Z} (e.g., Z=0-0.1).

With the solid oxide electrolyte according to a single cell of the embodiments, the composition of the solid oxide electrolyte is graded in accordance with the temperature gradient of the operation temperature of the solid oxide electrolyte, in other words, in accordance with the position of the solid oxide electrolyte. With the solid oxide electrolyte, the composition of the high temperature region T3 including relatively high operation temperature and the composition of the low temperature region T1 including relatively low operation temperature are determined to be different. Thus, the high ion conduction in accordance with each operation temperature can be obtained on each region, the high temperature region T3, the intermediate temperature region T2, and the low temperature region T1 of the solid oxide electrolyte. Accordingly, the favorable power density can be obtained in each region including the high temperature region T3, the intermediate temperature region T2, and the low temperature region T1 of the solid oxide electrolyte.

According to the first composition embodiment, the composition of the anode is graded in accordance with the temperature gradient of the operation temperature, that is, in accordance with the portion of the anode. The composition of the high temperature region T3 having relatively high operation temperature and the composition of the low temperature region T1 having relatively low temperature are different in the anode. Thus, high electronic conduction in accordance with the respective operation temperature is obtained in each region including the high temperature region T3, the low temperature region T1, and the intermediate temperature region T2.

The composition of the cathode is also graded in accordance with the temperature gradient of the operation temperature, that is, in accordance with the portion of the cathode. The cathode includes different compositions on the high temperature region T3 having relatively high operation temperature and the low temperature region T1 having the relatively low operation temperature. Thus, the high electronic conduction and oxidation resistance in accordance with the respective operation temperature is obtained in each region including the high temperature region T3, the low temperature region T1, and the intermediate temperature region T2.

The composition of the inter-connector is also graded in accordance with the temperature gradient of the operation temperature, that is, in accordance with the portion of the inter-connector. The inter-connector includes different compositions on the high temperature region T3 having relatively high operation temperature and the low temperature region T1 having the relatively low operation temperature. Thus, the high electronic conduction and oxidation resistance in accordance with the respective operation temperatures is obtained in each region including the high temperature region T3, the low temperature region T1, and the intermediate temperature region T2.

According to a second composition embodiment, the solid oxide electrolyte includes the composition region having the oxide of the stabilized zirconia system stabilized by at least one of yttria and scandia as the base material. In this case, the stabilized zirconia may be determined as the oxide having the composition formula of Zr_{0.8}Sc_{0.2-X}Y_{X}O_{1.9-Z}. X is varied within the range between zero and 0.2 (X=0-0.2). Thus, the graded composition for gradually increasing the value of X within the range of zero to 0.2 (X=0-0.2) as moving the operation temperature from the low temperature region T1 to the high temperature region T3 via the intermediate temperature region T2 is formed to reduce the scandium while the yttrium is increased. This is for obtaining the high ion conduction. X in the formula above may be 0, 0.01, 0.02, 0.03, 0.04, 0.05, 0.06, 0.07, 0.08, 0.09, 0.1, 0.11, 0.12, 0.13, 0.14, 0. 1 5, 0.16, 0.17, 0.18, 0.19, and 0.2 as appropriate. Z in the formula above may be 0, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, and 0.4 as appropriate. In this case, in the high temperature region T3, X is determined to be 0.2 (X=0.2) with the foregoing composition formula to make scandium zero so that the high temperature region T3 includes an even composition, that is, the high temperature region T3 includes the composition formula of Zr_{0.8}Y_{0.2}O_{1.91-Z}. Producing the high temperature region T3 with the even composition is believed to restrain the influence by the diffusion of the element because the degree of diffusion is larger in the high temperature region T3 compared to the low temperature region T1. With the stabilized zirconia, the composition of the stabilized zirconia may include slightly higher Zr ratio because mole ratio of yttria and scandia can exist within the range between seven and eleven percent. Thus, the composition range can be achieved between Zr_{0.8}Sc_{0.2-X}Y_{X}O_{1.9-Z} to Zr_{0.87}Sc_{0.13-X}Y_{X}O_{1.9-Z}. When the composition is determined to be Zr_{0.87}Sc_{0.13-X}Y_{X}O_{1.9-Z}, Z is determined to be between zero and 0.4 and X is determined to be between zero and 0.13 (Z=0-0.4, X=0-0.13). Z in the formula above may be 0, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, and 0.4 as appropriate. X in the formula above may be 0, 0.01, 0.02, 0.03, 0.04, 0.05, 0.06, 0.07, 0.08, 0.09, 0.1, 0.11, 0.12, and 0.13 as appropriate.

The anode is supplied with the fuel gas, electrochemically oxidizes the fuel gas, and generates the electron. Considering the foregoing function of the anode, the low temperature region T1 of the anode includes cermet in which nickel as metal phase and ceria oxide as ceramics phase are mixed. The nickel is included in order to obtain the catalytic activity relatives to the fuel gas.

According to the second composition embodiment, the anode includes the cermet shown in the composition formula of Ni—Ce_{1-X}B_{X}O_{1.95-δ} (e.g., δ=0-0.45). In the foregoing composition formula, B element corresponds to one or two or more than two kinds of samarium (Sm), gadolinium (Gd), yttrium (Y), and lanthanum (La). In this case, the value of X is gradually reduced from 0.3 to be closer to 0.2 as moving to the portion increasing the operation temperature of the solid oxide electrolyte 10 (X=0.3-0.2). X in the formula may be 0.2, 0.21, 0.22, 0.23, 0.24, 0.25, 0.26, 0.27, 0.28, 0.29, and 0.3 as appropriate. δ in the formula above may be 0, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, 0.4, 0.41, 0.42, 0.43, 0.44 and 0.45 as appropriate.

In the intermediate temperature region T2, the anode includes the mixed material of Ni—YSZ cermet and cermet shown with the composition formula of Ni—Ce_{0.8}B_{0.2}O_{1.9-δ} (e.g., δ=0-0.40). This is determined considering the thermal resistance and the electronic conduction at the intermediate temperature region T2. In this composition formula, B element corresponds to one or two or more than two kinds of samarium (Sm), gadolinium (Gd), yttrium (Y), and lanthanum (La). The Ni—YSZ cermet corresponds to the cermet including nickel phase and YSZ phase. In the intermediate temperature region T2 of the anode, the graded composition increasing the ratio of the dimension of the Ni—YSZ cermet as moving to the portion increasing the operation temperature is applied. It is for dealing with the high operation temperature.

In the high temperature region T3, the anode includes the cermet including Ni serving as the metal phase and yttria stabilized zirconia serving as the ceramic phase. This is for considering the thermal resistance, the ion conduction, the electron conduction, and the reduction of the element diffusion.

The cathode is supplied with the air serving as the oxygen bearing material functioning as the oxidizer, is the place for reaction between the oxygen and the electron, and serves as the conduction passage for supplying the electron from the external load to the reaction place. Thus, the cathode preferably reduces the oxygen to oxygen ion, exhibits high electron conduction, and exhibits high ion conduction. With the cathode having the foregoing function, the low temperature region T1 includes the oxide shown as the composition formula of B_{0.6}Sr_{0.4}MnO_{3-δ} (e.g., δ=0-0.25). This is determined considering the high electronic conduction of the low temperature region Ti. In this composition formula, at least part of Sr is replaceable with Ca. In this composition formula, B element corresponds to one or two or more than two kinds of samarium (Sm), gadolinium (Gd), yttrium (Y), and lanthanum (La). δ in the formula above may be 0, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, and 0.25 as appropriate.

In the intermediate temperature region T2, the cathode includes the layered construction having an internal layer on the solid oxide electrolyte side and an external layer on the air layer side. The internal layer on the solid oxide electrolyte side includes the ceria-zirconia oxide shown as (Ce_{1-X}Zr_{X})_{0.8}B_{0.2}O_{1.91-δ} (e.g., δ=0-0.41). δ in the formula above may be 0, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, 0.4 and 0.41 as appropriate. In this case, the value of X can be increased from zero to 0.5 as moving to the portion having the high operation temperature. In this composition formula, B element corresponds to one or two or more than two kinds of samarium (Sm), gadolinium (Gd), yttrium (Y), and lanthanum (La). The oxide shown as the composition formula of B_{0.5}Sr_{0.5}MnO_{3-δ} (e.g., δ=0-0.25) is applied to the external layer on the air side. In this composition formula, B element corresponds to one or two or more than two kinds of samarium (Sm), gadolinium (Gd), yttrium (Y), and lanthanum (La). In this composition formula, at least part of Sr can be replaced with Ca. X in the formula above may be 0, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49, and 0.5 as appropriate. δ in the formula above may be 0, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, and 0.25 as appropriate.

In the high temperature region T3, the cathode is also formed with the layered construction having an internal layer on the solid oxide electrolyte side and an external layer on the air layer side. The internal layer on the solid oxide electrolyte side includes the ceria-zirconia oxide shown as (Ce_{1-X}Zr_{X})_{0.8}B_{0.2}O_{1.91-δ} (e.g., δ=0-0.41). δ in the formula above may be 0, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, 0.4 and 0.41 as appropriate. In this case, the value of X can be increased from 0.5 to 1.0 as moving to the portion having the high operation temperature. In this composition formula, B element corresponds to one or two or more than two kinds of samarium (Sm), gadolinium (Gd), yttrium (Y), and lanthanum (La). The oxide shown as the composition formula of B_{0.6}Sr_{0.4}MnO_{3-δ} (e.g., δ=0-0.25) is applied to the external layer on the air side. In this composition formula, B element corresponds to one or two or more than two kinds of samarium (Sm), gadolinium (Gd), yttrium (Y), and lanthanum (La). In this composition formula, at least part of Sr can be replaced with Ca. X in the formula above may be 0.5, 0.51, 0.52, 0.53, 0.54, 0.55, 0.56, 0.57, 0.58, 0.59, 0.6, 0.61, 0.62, 0.63, 0.64, 0.65, 0.66, 0.67, 0.68, 0.69, 0.7, 0.71, 0.72, 0.73, 0.74, 0.75, 0.76, 0.77, 0.78, 0.79, 0.8, 0.81, 0.82, 0.83, 0.84, 0.85, 0.86, 0.87, 0.88, 0.89, 0.9, 0.91, 0.92, 0.93, 0.94, 0.95, 0.96, 0.97, 0.98, 0.99, and 1.0 as appropriate. δ in the formula above may be 0, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, and 0.25 as appropriate.

An inter-connector according to the second composition embodiment is formed likewise the inter-connector according to the first composition embodiment.

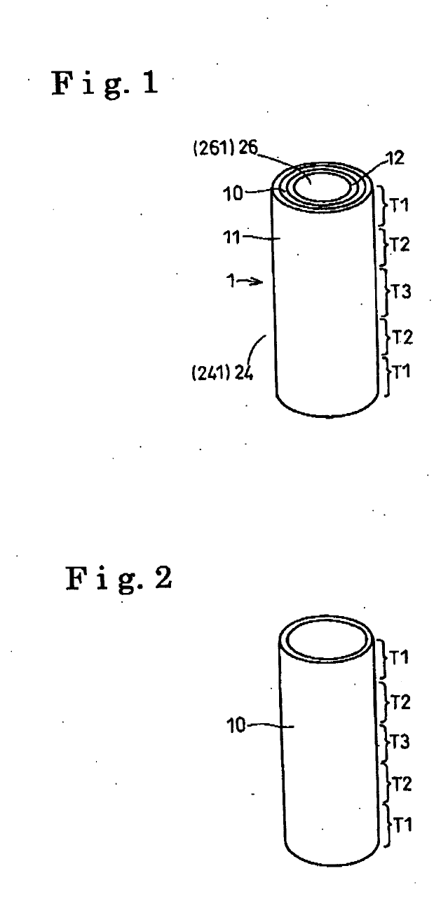

A first embodiment of a solid oxide electrolyte fuel system will be explained with reference to FIGS. 1-5 as follows. A cell 1 according to the solid oxide electrolyte fuel system includes a cylindrical solid oxide electrolyte 10 exhibiting the ion condition, a cylindrical porous anode 11 provided on a one side (external peripheral side) in the thickness direction of the solid oxide electrolyte 10, and a cylindrical porous cathode 12 provided on the other side (internal peripheral side) in the thickness direction of the solid oxide electrolyte 10.

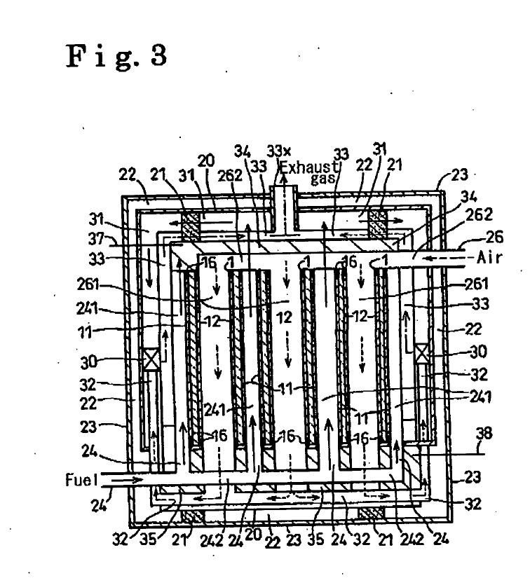

As shown in FIGS. 1-2, the central region in the axially longitudinal direction of the solid oxide electrolyte 10 is determined to be the high temperature region T3 (e.g., 900-1100° C.). End regions in the axial direction of the solid oxide electrolyte 10 are determined to be the low temperature region T1 (e.g., equal to or greater than 500° C. less than 700° C.). The intermediate temperature region T2 (e.g., greater than 700° C. less than 900° C.) is positioned between the solid oxide electrolyte 10 and the low temperature region T1 on the solid oxide electrolyte 10.

As shown in FIG. 3, the solid oxide electrolyte fuel system includes an internal base body 20 configured to accommodate plural cells 1 in parallel one another, an external base body 23 configured to support the internal base body 20 via a cell supporting portion 21 having the a diathermancy and an a diathermic layer 22, a fuel supply passage 24 configured to supply the gas formed fuel (e.g., hydrocarbon system gas) to the anode 11 of the cell 1, an air supply passage 26 configured to supply the gas formed air functioning as the oxidizer to the cathode 12 of the cell 1, a combustion portion 30 serving as a heating portion for burning the fuel off gas, a fuel off gas passage 31 configured to supply the fuel off gas exhausted from the fuel supply passage 24 to the combustion portion 30, an air off gas passage 32 configured to exhaust the exhaust gas combusted in the combustion portion 30, an exhaust gas passage 33 for exhausting the combusted exhaust gas in the combustion portion 30 to the outside, a first inter connector 34 for current collecting for electrically connecting one ends (top ends) of each cell 1, a second inter-connector 35 for current collection for electrically connecting the other ends (bottom ends) of each cell 1, an electrode terminal 37 connected to the first inter-connector and projected to the outside, and an electrode terminal 38 connected to the second inter-connector 35 and projected to the outside.

A sealing portion 16 configured to restrain the leakage of the fuel and the air is provided around the low temperature regions T1 on both end portions in the axial longitudinal direction of the solid oxide electrolyte 10.

As shown in FIG. 3, the fuel supply passage 24 includes a first fuel supply passage 241 facing the anode 11 and a second fuel supply passage 242 connected to the first fuel supply passage 241. The air supply passage 26 includes a first air supply passage 261 facing the cathode 12 which is an internal peripheral portion of the cell 1 and a second air supply passage 262 connected to the first air supply passage 261.

When starting generating power, the solid oxide electrolyte 10 is heated to have a predetermined high temperature region. When starting the operation of the system, it is not necessary that the entire portion of the solid oxide electrolyte 10 is heated to have the high temperature equal to or higher than 900° C. As shown in FIG. 2, an intermediate region in the longitudinal direction of the solid oxide electrolyte 10 is determined to have the high temperature region T3 (e.g., equal to or higher than 900° C. and less than 1100° C.), the end regions in the longitudinal direction of the solid oxide electrolyte 10 is determined to be the low temperature region T1 (e.g., equal to or higher than 500° C. and less than 700° C.) and a region between the low temperature region T1 and the solid oxide electrolyte 10 is determined to be the intermediate temperature region T2 (e.g., equal to or higher than 700° C. less than 900° C.). Thus, the low temperature region T1 and the intermediate temperature region T2 other than the high temperature region T3 are allowed. The low temperature region T1 is determined because of the construction that the end regions in the longitudinal direction of the solid oxide electrolyte 10 are connected to the external base body 23 via the cell supporting portion 21. On the other hand, the high temperature region T3 is determined because of the construction that the central region in the longitudinal direction of the solid oxide electrolyte 10 is close to the combustion portion 30 and relatively far from the external base body 23.

When power is generated, the fuel gas of the hydrocarbon system is supplied to the fuel supply passage 24 of the cell 1 and the air serving as the oxygen bearing material functioning as the oxidizer is supplied to the air supply passage 26 of the cell 1. Thus, power is generated. As shown in FIG. 3, the flow of the fuel and the fuel off gas is indicated with an arrow with solid line. The flow of the air and air off gas is indicated with an arrow with dotted line. The fuel gas after power generation exhausted from the fuel supply passage 24 of the cell 1 is supplied to the combustion portion 30 via the fuel off gas 31. The air off gas after power generation exhausted from the air supply passage 26 of the cell I is supplied to the combustion portion 30 via the air off gas passage 32. The air off gas and the fuel off gas are mixed and combusted in the combustion portion 30. The exhausted heat is recycled by an exhaust heat using device. The exhaust gas combusted in the combustion portion 30 is exhausted from an exhaustion pipe 33x via an exhaust gas passage 33. The flow of the exhaust gas in FIG. 3 is shown with an arrow with chain line.

According to the embodiment shown in FIGS. 1-3, as foregoing, the composition of the solid oxide electrolyte 10 is varied based on one of the first composition embodiment and the second composition embodiment in accordance with the temperature gradient of the operation temperature of the solid oxide electrolyte 10, in other words, in accordance with the portion of the solid oxide electrolyte 10 in the longitudinal direction. As a result, the solid oxide electrolyte 10 is determined to have different compositions on the high temperature region T3 having relatively high operation temperature and the low temperature region T1 having relatively low operation temperature to increase the power density at the low temperature region T1.

Accordingly, it is not necessary to keep the temperature of the entire cell 1 to be high and even. Thus, it is not required to maintain the entire portion of the solid oxide electrolyte 10 to be high temperature region equal to or higher than 900° C., the time for starting the electric power generation can be shortened, and the electric power generation can be effectively performed. Further, because it is not required to increase the temperature of the entire solid oxide electrolyte 10 to be equal to or higher than 900° C., the end regions of the solid oxide electrolyte 10 is remained to be the low temperature region T1 having the temperature equal to or higher than 500° C. and less than 700° C. to restrain the heat leakage amount to the outside during the operation of the system.

According to the embodiment, end portions of the solid oxide electrolyte 10 is determined to be the low temperature region T1 (e.g., equal to or higher than 500° C. and less than 700° C.). Thus, the fuel cell can be favorably operated even if the temperature of each part such as an inlet of the fuel supply passage 24, an inlet of the air supply passage 26, a portion for drawing electrode terminals such as the electrode terminals 37, 38, and the cell supporting portion 21 is determined lower than the high temperature region T3 and the intermediate temperature region T2 of the solid oxide electrolyte 10.

With the solid oxide electrolyte 10 of the cell 1 according to the first embodiment, the composition of the solid oxide electrolyte 10 is varied corresponding to the temperature gradient of the operation temperature of the solid oxide electrolyte 10. In other words, the solid oxide electrolyte 10 is determined to have different compositions at the high temperature region T3 having relatively high operation temperature and the low temperature region T1 having relatively low operation temperature. Thus, the high ion conduction in accordance with each operation temperature can be obtained at the high temperature region T3, the intermediate temperature region T2, and the low temperature region T1 of the solid oxide electrolyte 10. Therefore, the favorable power density can be obtained at the high temperature region T3, the intermediate temperature region T2, and the low temperature region T1 of the solid oxide electrolyte 10.

According to the embodiment, the anode 11 and the cathode 12 are formed based on either one of the first composition embodiment and the second composition embodiment in accordance with the portion of the solid oxide electrolyte 10 in the longitudinal direction, that is, in accordance with the temperature gradient of the operation temperature of the solid oxide electrolyte 10. Thus, the electronic conduction of the anode 11 and the cathode 12 are favorably ensured even when the temperature gradient of the operation temperature is observed.

The inter-connectors 34, 35 are formed based on either one of the first composition embodiment and the second composition embodiment in accordance with the temperature gradient of the operation temperature of the solid oxide electrolyte 10, that is, corresponding to the portion of the solid oxide electrolyte 10 in the longitudinal direction. Thus, the electronic conduction of the inter-connectors 34, 35 can be favorably ensured despite the temperature gradient of the operation temperature.

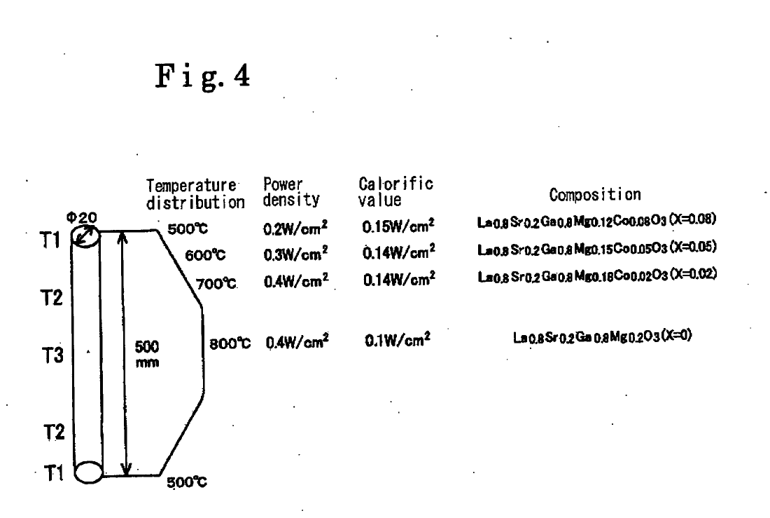

FIG. 4 shows the temperature distribution of the solid oxide electrolyte 10, the power density of the solid oxide electrolyte 10, the calorific value (i.e., calorific value for the electronic conduction) of the solid oxide electrolyte 10, and the composition of the solid oxide electrolyte 10. The output evaluation of the fuel cell of 1 kW class having the plural cells 1 arranged in parallel one another is obtained by the calculation. In this case, cobalt (Co) is applied as A element and the solid oxide electrolyte 10 is determined to be the oxide of the lanthanum system having the composition formula shown basically as La_{0.8}Sr_{0.2}Ga_{0.8}Mg_{0.2-X}Co_{X}O₃. In addition, the solid oxide electrolyte 10 includes the graded composition having the value of X gradually reduced from 0.08 to the zero from the low temperature region T1 to the intermediate temperature region T2. The solid oxide electrolyte 10 is determined to have 20 mm of internal diameter and 500 mm of height. As shown in FIG. 4, the temperature distribution of the cylindrical solid oxide electrolyte 10 is determined to be 500° C. at the both ends of the solid oxide electrolyte 10 and to be 800° C. at the central region (the portion having 200 mm of size) in the longitudinal direction of the solid oxide electrolyte 10. The temperature between the central region and the both ends (i.e., portion having 150 mm of size) is gradually varied. In this case, the thickness of the solid oxide electrolyte 10 is determined to be 0.3 mm. X in the formula above may be 0, 0.005, 0.01, 0.015, 0.02, 0.025, 0.03, 0.035, 0.04, 0.045, 0.05, 0.055, 0.06, 0.065, 0.07, 0.075, and 0.08 as appropriate.

As shown in FIG. 4, the power density is determined to be 0.4 W/cm² and the calorific value (i.e., calorific value for the electronic conduction) is determined to be 0.1 W/cm² in the region having 800° C. of the solid oxide electrolyte 10. The power density is determined to be 0.4 W/cm² and the calorific value (i.e., calorific value for the electronic conduction) is determined to be 0.14 W/cm² in the region having 700° C. of the solid oxide electrolyte 10. The power density is determined to be 0.3 W/cm² and the calorific value (i.e., calorific value for the electronic conduction) is determined to be 0.14 W/cm² in the region having 500° C. of the solid oxide electrolyte 10. With the calculation example, favorable power density of 0.2 W/cm² can be achieved in the low temperature region having approximately 500° C. of the solid oxide electrolyte 10. As a result, favorable power density can be obtained even if the operation temperature of the solid oxide electrolyte 10 is varied. In other words, even when the temperature gradient of the operation temperature of the solid oxide electrolyte 10 is generated, the irregularity of the electric power generation at each portion of the solid oxide electrolyte 10 is mitigated. With the foregoing calculation example, the electric power generation output may be 113 W per each cylindrical solid oxide electrolyte 10. With the cell module having the sixteen solid oxide electrolytes 10 arranged in parallel one another, the electric power generation output of 1808 W can be obtained. The caloric value of each cylindrical solid oxide electrolyte 10 may be 40 W and 640 W of caloric value can be obtained by arranging sixteen solid oxide electrolytes 10 in parallel.

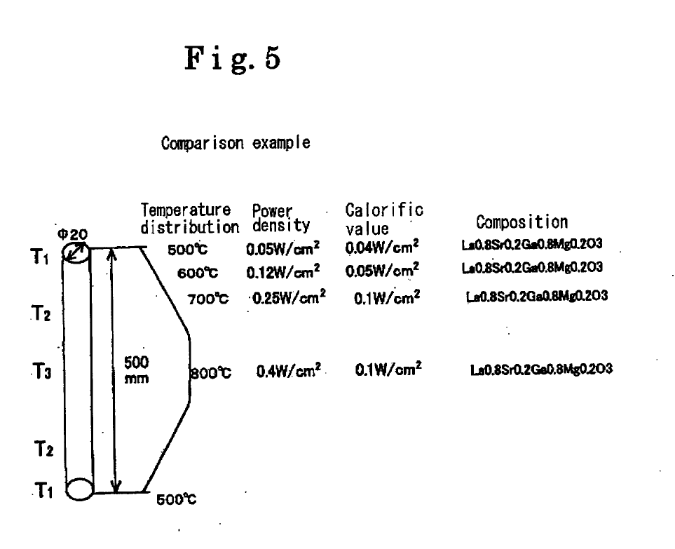

FIG. 5 shows the temperature distribution of a comparison example, the power density of the solid oxide electrolyte, the caloric value (i.e., caloric value for the electronic conduction) of the solid oxide electrolyte, and the composition of the solid oxide electrolyte. The solid oxide electrolyte in the comparison example includes a fixed composition without grading and determined to be the oxide having the composition formula shown as La_{0.8}Sr_{0.2}Ga_{0.8}Mg_{0.2}O₃. The size of the solid oxide electrolyte is determined to have 20 mm of internal diameter and 500 mm of the height. As shown in FIG. 5, the power density is determined to be 0.4 W/cm² and the calorific value (i.e., calorific value for the electronic conduction) is determined to be 0.1 W/cm² in the region having 800° C. of the solid oxide electrolyte 10. The power density is determined to be 0.25 W/cm² and the calorific value (i.e., calorific value for the electronic conduction) is determined to be 0.1 W/cm² in the region having 700° C. of the solid oxide electrolyte 10. The power density is determined to be 0.12 W/cm² and the calorific value (i.e., calorific value for the electronic conduction) is determined to be 0.05 W/cm² in the region having 600° C. of the solid oxide electrolyte 10. The power density is determined to be 0.05 W/cm² and the calorific value (i.e., calorific value for the electronic conduction) is determined to be 0.04 W/cm² in the region having 500° C. of the solid oxide electrolyte 10.

According to the comparison example, the power density at the region having operation temperature lower than 700° C. is quite small. With the comparison example, 82 W of the electric power output may be obtained per each solid oxide electrolyte and thus the cell module including sixteen solid oxide electrolytes arranged in parallel one another obtains the electric power output of 1312 W. The calorific value of each cylindrical solid oxide electrolyte may be determined to be 26 W and 416 W of calorific value can be obtained as arranging sixteen solid oxide electrolytes.

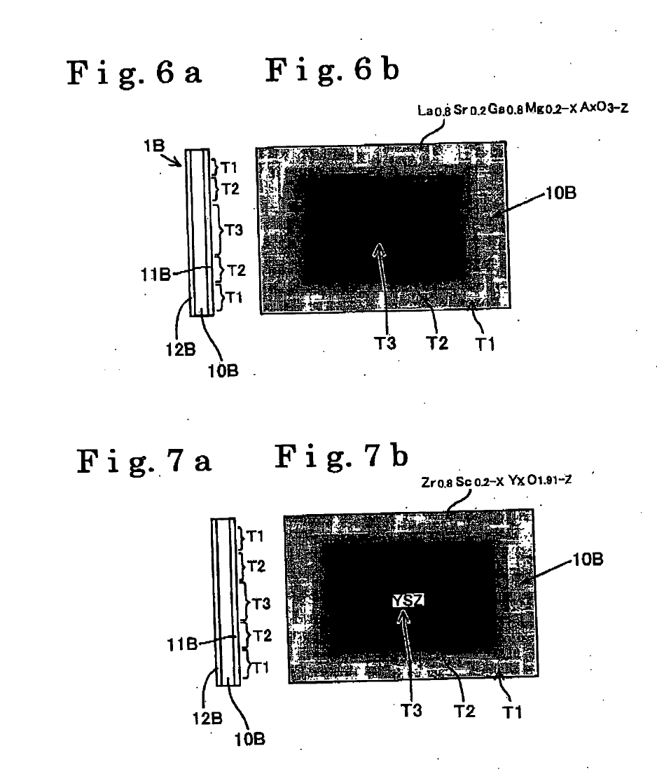

A second embodiment of the present invention will be explained with reference to FIGS. 6-8. As shown in FIG. 6a and 6b, a rectangular plate shaped cell 1B applied to the solid oxide fuel cell system of the embodiment includes a plate configured solid oxide electrolyte 10B having the oxygen ion conduction, an rectangular plate configured anode 11B provided on one side (one surface side) of the solid oxide electrolyte 10B, and a rectangular plate configured cathode 12B provided on the other side (other one side surface) of the solid oxide electrolyte 10B. The central region of the solid oxide electrolyte 10B is determined to be the high temperature region T3 (e.g., equal to or higher than 900° C. and less than 1100° C.). A periphery of the solid oxide electrolyte 10B is determined to be the low temperature region T1 (e.g., equal to or higher than 500° C. and less than 700° C.). The intermediate temperature region T2 (e.g., equal to or higher than 700° C. and less than 900° C.) is positioned between the high temperature region T3 and the low temperature region T1 of the solid oxide electrolyte 10B.

Thus, as shown in FIG. 6b, the solid oxide electrolyte 10B formed with the first composition embodiment includes the oxide having the composition formula of La_{0.8}Sr_{0.2}Ga_{0.8}Mg_{0.2-X}A_{X}O_{3-Z} as the base material. As shown in FIG. 7b, the solid oxide electrolyte 10B formed with the second composition embodiment includes the oxide having the composition formula of Zr_{0.8}Sc_{0.2-X}Y_{X}O_{1.91-Z} as the base material.

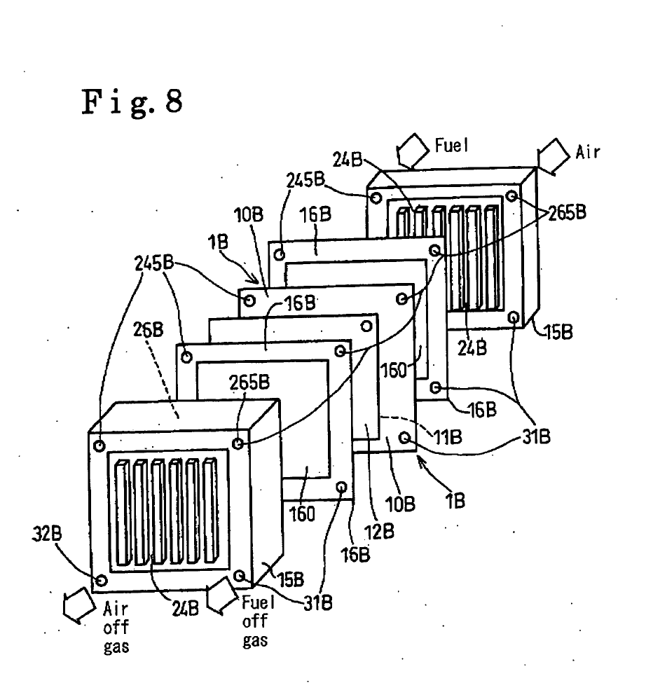

The entire construction of the solid oxide fuel cell system of the second embodiment will be explained with reference to FIG. 8. As shown in FIG. 8, the solid oxide fuel cell system includes the solid oxide electrolyte 10B, a cell 1B including the anode 11B and the cathode 12B, rectangular plate shaped separators 15B, 15B provided for sandwiching the cell 1B, and a sealing portion 16B having an opening 160 and provided between the separator 15B and the solid oxide electrolyte 10B.

The solid oxide electrolyte 10B of the second embodiment includes the varied composition graded in accordance with the portion, in other words, in accordance with the temperature gradient of the operation temperature of the solid oxide electrolyte 10B. The solid oxide electrolyte 10B is formed based on either one of the first composition embodiment and the second composition embodiment and different compositions are determined for the composition of the high temperature region T3 having relatively high operation temperature and the composition of the low temperature region T1 having relatively low operation temperature. It is for obtaining the high ion conduction corresponding to each operation temperature of the solid oxide electrolyte 10B.

Likewise the anode 11 of the first embodiment, the anode 11B is formed based on one of the first composition embodiment and the second composition embodiment and the composition of the anode is varied in accordance with the temperature gradient of the operation temperature of the solid oxide electrolyte 10B. Likewise the cathode 12 of the first embodiment, the cathode 12B is formed based on one of the first composition embodiment and the second composition embodiment and the composition of the cathode is varied in accordance with the temperature gradient of the operation temperature of the solid oxide electrolyte 10B.

The separator 15B includes the electric conductive material (e.g., Ni—Cr system stainless steel) and functions as the inter-connector for collecting the electricity for electrically connecting to the cell 1B.

A fuel supply passage 24 configured to supply the fuel (e.g., hydrocarbon system gas) to the anode 11B of the cell 1B is formed on one surface of the separator 15B. An air supply passage 26B serving as the oxide passage configured to supply the air (i.e., air bearing gas) serving as the oxide to the cathode 12B of the cell 1B is provided on the other side of the separator 15B.

A fuel passage 245B configured to supply the fuel gas to the fuel supply passage 24B is formed on a corner of the separator 15B, on a corner of the solid oxide electrolyte 10B, and on a corner of the sealing portion 16B. An air passage 265 configured to supply the air to the air supply passage 26B of the separator 15B is formed on another corner of the separator 15, on another corner of the solid oxide electrolyte 10B, and on another corner of the sealing portion 16B.

A fuel off gas passage 31B configured to exhaust the fuel off gas exhausted from the fuel supply passage 24B of the separator 15B is formed on another corner portion of the separator 15B, on another corner of the solid oxide electrolyte 10B, and on another corner of the sealing portion 16B. An air off gas passage 32B configured to exhaust the air off gas exhausted from the air supply passage 26B of the separator 15B is formed on another corner portion of the separator 15, on another corner of the solid oxide electrolyte 10B, and on another corner of the sealing portion 16B.

When the electric power is generated, the fuel gas such as hydrocarbon system, or the like is supplied to the fuel supply passage 24B of the separator 15B and the air including the oxygen is supplied to the air supply passage 26B of the separator 15B. Thus, the electricity is generated. The fuel off gas after the electric power generation exhausted from the fuel supply passage 24B of the separator 15B is exhausted via the fuel off gas passage 31B. The air off gas after electric power generation exhausted from the air supply passage 26B of the separator 15B is exhausted via the air off gas passage 32B.

Because end region of the solid oxide electrolyte 10B is close to the external portion during the electric power generation, the end region is determined to be the low temperature region T1. The central region of the solid oxide electrolyte 10B is determined to be the high temperature region T3 because the central region is relatively far from the external portion.

As shown in FIG. 8, the sealing portion 16B seals the low temperature region T1 corresponding to the periphery of the solid oxide electrolyte 10B to restrain the leakage of the fuel and the air to the outside. The sealing portion 16B may be formed with one of glass system, the ceramic system, the carbon system, cermet system, and the metal system. Because the sealing portion 16B seals the low temperature region T1 having the relatively low operation temperature compared to the high temperature region T3 on the solid oxide electrolyte 10B, the extreme thermal resistance is not required to the sealing portion 16B. Thus, the thermal degradation of the sealing portion 16B is prevented, the life of the sealing portion 16B may be elongated, and the degree of freedom for selecting the material for the sealing portion 16B is expanded. With the embodiment, it is not required to maintain the entire solid oxide electrolyte 10B in the high temperature region during the operation of the system and rising time to start the operation of the solid oxide fuel cell system can be shortened. Further, the thermal leakage amount to the outside during the operation of the system can be restrained.

As explained above, with the embodiment, the low temperature region T1 (e.g., equal to or higher than 500° C. and less than 700° C.) is applied to the end region of the solid oxide electrolyte 10B. Thus, the fuel cell can be favorably operated even if the temperature of each part such as an inlet of the fuel supply passage 24B, an inlet of the air supply passage 26B, and a portion for drawing the electrode terminals is determined to be lower than the high temperature region T3 and the intermediate temperature region T2 of the solid oxide electrolyte 10B.

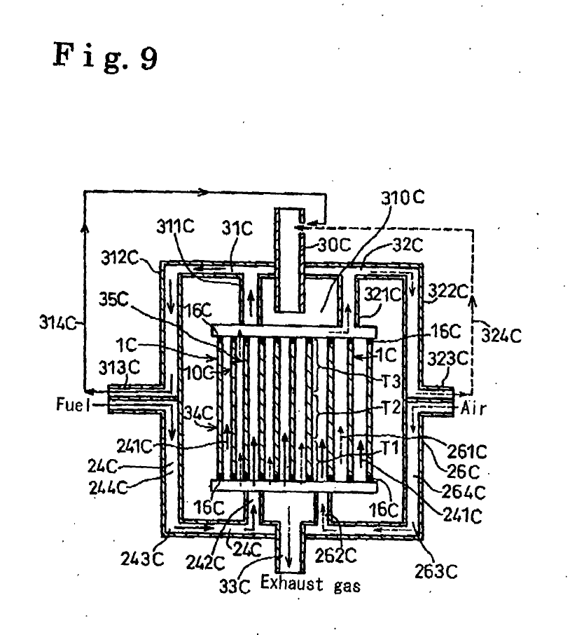

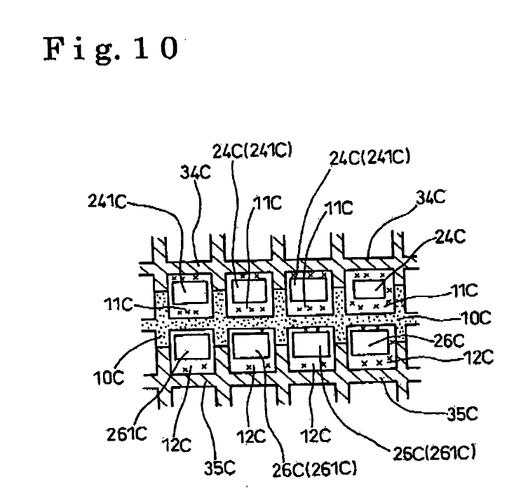

A third embodiment of the present invention will be explained with reference to FIGS. 9-10. A cell 1C having a honeycomb configuration in the cross section of the solid oxide fuel cell system according to the third embodiment includes a solid oxide electrolyte 10C having honeycomb configuration and including the ion conduction and extended in the height direction, a cylindrical anode 11C extended in the height direction and provided on one side of the solid oxide electrolyte 10C, and a cylindrical cathode 12C extended in the height direction and provided on the other end of the solid oxide electrolyte 10C.

With the solid oxide electrolyte 10C, one end region (i.e., top end region in FIG. 9) in the height direction is determined to be the high temperature region T3 (e.g., equal to or higher than 900° C. and less than 1100° C.). It is because the top end region is close to a combustion chamber 310C heated to be high temperature. The other end region (i.e., bottom end region in FIG. 9) in the height direction is determined to be the low temperature region T1 (e.g., equal to or higher than 500° C. and less than 700° C.). The portion between the high temperature region T3 and the low temperature region T1 of the solid oxide electrolyte 10C in the longitudinal direction is determined to be the intermediate temperature region T2 (e.g., equal to or higher than 700° C. and less than 900° C.).

The solid oxide electrolyte 10C according to the third embodiment varies the composition along the height direction (i.e., along the longitudinal direction) in accordance with the temperature gradient of the operation temperature likewise the solid oxide electrolyte 10 of the first embodiment. In other words, the solid oxide electrolyte 10C is formed based on one of the first composition embodiment and the second composition embodiment. And thus, the solid oxide electrolyte 10C is determined to have different compositions on the high temperature region T3 having relatively high operation temperature and the low temperature region T1 having relatively low operation temperature to increase the power density of the low temperature region T1.

As shown in FIG. 10, the solid oxide fuel cell system of the third embodiment includes the solid oxide electrolyte 10C, the cell 1C including the anode 11C and the cathode 12C, a fuel supply passage 24C configured to supply the fuel (e.g., hydrocarbon system gas) to the anode 11C of the cell 1C, a first inter-connector 34C extended in the height direction along the anode 11C, and a second inter-connector 35C extended in the height direction along the cathode 12C.

As shown in FIG. 9, the fuel supply passage 24C includes a first fuel supply passage 241C facing the anode 11C of the honeycomb shaped cell 1C, a second fuel supply passage 242C connected to the first fuel supply passage 241C, a third fuel supply passage 243C connected to the second fuel supply passage 242C, and a fourth fuel supply passage 244C connected to the third fuel supply passage 243C.

As shown in FIG. 9, an air supply passage 26C includes a first air supply passage 261C facing the cathode 12C of the honeycomb shaped cell 1C, a second air supply passage 262C connected to the first air supply passage 261C, a third air supply passage 263C connected to the second air supply passage 262C, and a fourth air supply passage 264C connected to the third air supply passage 263C. Further, the solid oxide fuel cell system of the third embodiment includes a fuel off gas passage 31C configured to exhaust the fuel off gas after power generation, an air off gas passage 32C configured to exhaust the air off gas after the power generation, a combustion portion 30C corresponding to the combustion burner serving as a heating portion for combusting the mixed gas including the fuel off gas and the air off gas, and an exhaust gas passage 33C configured to exhaust the exhaust gas combusted in the combustion portion 30C to the outside.

As shown in FIG. 9, the fuel off gas passage 31C for exhausting the fuel off gas after the power generation includes a first fuel off gas passage 311C, a second fuel off gas passage 312C connected to the first fuel off gas passage 311C, a third fuel off gas passage 313C connected to the second fuel off gas passage 312C, and a fourth fuel off gas passage 314C connected to the third fuel off gas passage 313C. The air off gas passage 32C for exhausting the air off gas after the power generation includes a first air off gas passage 321C, a second air off gas passage 322C connected to the first air off gas passage 321C, a third air off gas passage 323C connected to the second air off gas passage 322C, and a fourth air off gas passage 324C connected to the third air off gas passage 323C.

With the third embodiment of the present invention, the fuel gas of the hydrocarbon system is supplied to the fuel supply passage 24C and the air is supplied to the air supply passage 26C during the power generation. Thus, the fuel gas of the hydrocarbon system is supplied to the first fuel supply passage 241C of the cell 1C and the air is supplied to the first air supply passage 261C of the cell 1 to generate the electricity at the cell 1. As shown in FIG. 9, the flow of the fuel off gas is indicated with an arrow with solid line. The flow of the air and air off gas is indicated with an arrow with dotted line. The flow of the exhaust gas is indicated with an arrow with chain line.

The fuel off gas after the power generation is exhausted to the combustion portion 30 via the fuel off gas passage 31C as indicated with the arrow with solid line. Accordingly, the fuel off gas and the air off gas are combusted in the combustion portion 30C and the flame is generated in the combustion chamber 310C. Thus, the top end region in the longitudinal direction of the solid oxide electrolyte 10C is determined to be the high temperature region T3 and the bottom end region in the longitudinal direction of the solid oxide electrolyte 10C is determined to be the low temperature region T1. The portion between the high temperature region T3 and the low temperature region T1 is determined to be the intermediate temperature region T2.

The solid oxide electrolyte 10C of the cell 1C is formed based on one of the first composition embodiment and the second composition embodiment. The composition of the solid oxide electrolyte 10C is varied to be corresponding to the operation temperature of the solid oxide electrolyte 10C. Thus, high ion conduction can be obtained even on the low temperature region T1 and the intermediate temperature region T2 of the solid oxide electrolyte 10C.

Further, with the third embodiment, likewise the first and the second embodiments, the temperature gradient is formed on the solid oxide electrolyte 10C and it is not required to maintain the entire solid oxide electrolyte 10C to be the high temperature region. Accordingly, the rising time to start the operation can be shortened when starting the solid oxide fuel cell system and further the thermal leakage amount to the outside during the operation of the system can be retrained.

The sealing portion 16C is provided for restraining the leakage of the fuel and the air at the high temperature region T3 of the solid oxide electrolyte 10C. Further, the sealing portion 16C is provided in order to restrain the leakage of the fuel and the air at the low temperature region T1 of the solid oxide electrolyte 10C. Preferably, the sealing portion 16C configured to seal the low temperature region T1 is not required to have extreme thermal resistance because the sealing portion 16C is applied to the portion having relatively low temperature. This allows expanding the degree of freedom for selecting the material of the sealing portion 16C for sealing the low temperature region T1. The sealing portion 16C for sealing the low temperature region T1 may be made of one of the material of ceramic system, cermet system, metal system, and carbon system. The material with relatively low thermal resistance is applicable.

The anode 11C according to the third embodiment is formed based on one of the first composition embodiment and the second composition embodiment and the anode composition is varied depending on the temperature gradient of the operation temperature likewise the anode 11 of the first embodiment. Likewise the cathode 12 of the first embodiment, the cathode 12C is formed based on the first composition embodiment and the second composition embodiment and the cathode composition is varied depending on the temperature gradient of the operation temperature. Accordingly, favorable electronic conduction of the cathode 12C and the anode 11C is ensured.

In addition, the first inter-connector 34C and the second inter-connector 35C are formed based on the first composition embodiment and the second composition embodiment depending on the temperature gradient of the operation temperature. Thus, the electronic conduction of the first inter-connector 34C and the second inter-connector 35C is favorably ensured.

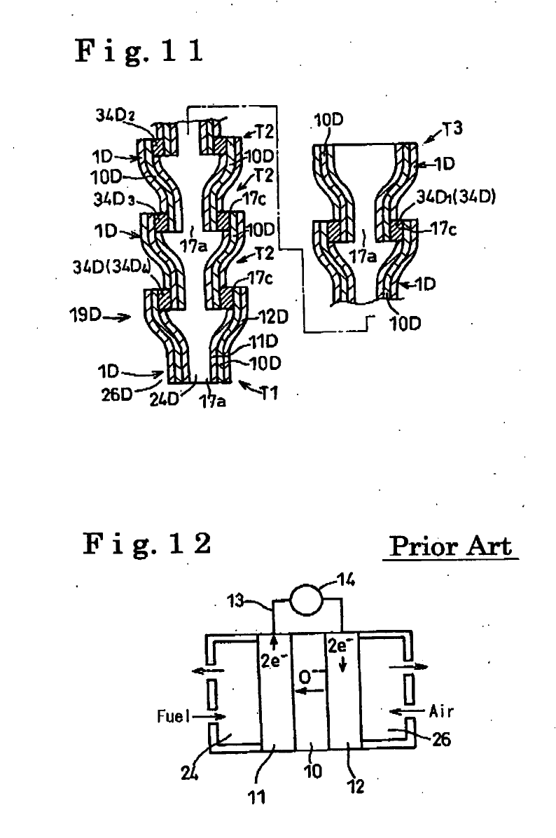

A cell 1D according to a fourth embodiment will be explained with reference to FIG. 11. With the solid oxide fuel cell system according to the fourth embodiment, the single tube shaped cell 1D includes a fitting portion 17a having a convex portion on one end in the longitudinal direction and a portion 17c to be fitted having the recess shape on the other end in the longitudinal direction. As shown in FIG. 11, the single tube shaped cell 1D includes a cylindrical solid oxide electrolyte 10D having the ion conduction, a cylindrical anode 11D provided on one side in the thickness direction of the solid oxide electrolyte 10D, and a cylindrical cathode 12D provided on the other side in the thickness direction of the solid oxide electrolyte 10D. The position of the cathode 12D and the anode 11D can be switched.

As shown in FIG. 11, the tube shaped cell 1D includes a fuel supply passage 24d configured to supply the fuel to the anode 11D and an air supply passage 26D configured to supply the air including the oxygen serving as the oxide to the cathode 12D. By fitting the fitting portion 17a to the portion 17c to be fitted of the cell 1D, a tube shaped cell module 19D can be formed by connecting the plural cells 1D in series.

On the cell module 19D, inter-connectors 34D (34D₁-34D₄) for collecting the electricity for electrically connecting to each cell 1D is provided between adjacent cells 1D. Because the plural tube shaped cells 1D are connected in series to form the cell module 19D, the single cell 1D can include the solid oxide electrolyte 10 having an even composition. The anode 11D and the cathode 12D are also formed as the even composition. The composition of the solid oxide electrolyte 10D may be changed between the adjacent cells D.

According to the fourth embodiment, one end region (i.e., top end region) in the longitudinal direction of the cell module 19D is determined to be the high temperature region T3 (e.g., equal to or higher than 900° C. and less than 1100° C.). The other end region (bottom end region) in the longitudinal direction of the cell module 19D is determined to be the low temperature region T1 (e.g., equal to or higher than 500° C. and less than 700° C.). The portion positioned between the low temperature region T1 and the high temperature region T3 is determined to be the intermediate temperature region T2 (e.g., equal to or higher than 700° C. and less than 900° C.).

According to the fourth embodiment, the inter-connector 34D₁ is close to the high temperature region T3 and the inter-connector 34D₄ is close to the low temperature region T1. Thus, the inter-connector 34D₁ on the high temperature side includes the oxide of lanthanum chromite (LaCrO₃) system having the perovskite construction as the base material considering the electronic conduction and the thermal resistance. More particularly, the inter-connector 34D₁ on the high temperature side includes the oxide shown as the composition formula of La_{0.8}Sr(or Ca)_{0.2}CrO_{3-Z} (e.g., Z=0-0.1) as the base material. Z in the formula above may be 0, 0.01, 0.02, 0.03, 0.04, 0.05, 0.06, 0.07, 0.08, 0.09, and 0.1 as appropriate.

On the other hand, the inter-connector 34D₁ on the low temperature region T1 side includes the metal system because the extreme thermal resistance is not required. More particularly, the inter-connector 34D₁ includes stainless alloy including iron-nickel-chrome as the base material. The inter-connector 34D₂ and the inter-connector 34D₃ on the intermediate temperature side includes the mixture (cermet) of the oxide shown as the composition formula of La_{0.8}Sr(or Ca)_{0.2}CrO_{3-Z} and stainless alloy including iron-nickel-chrome as the base material. This is determined concerning the electronic conduction and the thermal resistance.

With the cell module 19D, the solid oxide electrolyte 10D is determined to have different compositions in accordance with the temperature gradient of the operation temperature, in other words, depending on the portion. It is for increasing the ion conduction in accordance with the operation temperature of the solid oxide electrolyte 10D. With the cell module 19D, the low temperature region T1 of the solid oxide electrolyte 10D includes the ceria oxide having favorable ion conduction even on the low temperature region T1 as the base material. More particularly, the low temperature region T1 of the solid oxide electrolyte 10D includes the ceria oxide as base material having the composition formula of Ce_{0.8}B_{0.2}O_{1.9-δ} (e.g., δ=0-0.4). In the foregoing composition formula, B element includes at least one of samarium (Sm), gadolinium (Gd) or both. 6 in the formula above may be 0, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39 and 0.4 as appropriate.

The ceria oxide electrolyte likely to have more electronic conduction element at the high temperature compared to at the low temperature having relatively small electronic conduction element. Thus, it is not favorable to apply the ceria oxide to the solid oxide electrolyte 10D of the high temperature region T3 whose temperature is equal to or higher than 700° C. Thus, according to the fourth embodiment shown in FIG. 11, the intermediate temperature region T2 of the solid oxide electrolyte 10D on the cell module 19D includes yttria stabilized zirconia having favorable ion conduction or Scandia stabilized zirconia, or the like, as base material.

Further, with the high temperature region T3 of the cell module 19D, the solid oxide electrolyte 10D includes yttria stabilized zirconia as the base material. It is determined considering that ion conduction is favorable and the electronic conduction element is small at the high temperature region T3.

The solid solution including ceria oxide and zirconia may decline the ion conduction. In the fourth embodiment of the present invention, because the cell module 19D is configured by connecting the plural cells 1D in series, by forming the solid oxide electrolyte 10D of the cell 1D on the low temperature side with ceria oxide as base material and forming the solid oxide electrolyte 10D of the cell 1D on the high temperature side with zirconia, the reciprocal diffusion between ceria oxide and zirconia can be restrained. Thus, the generation of the solid solution can be reduced or avoided.

According to the first embodiment of the present invention, the cell 1 includes the solid oxide electrolyte 10, the cylindrical porous anode 11 provided on the external peripheral side in the thickness direction of the solid oxide electrolyte 10, and the cylindrical porous cathode 12 provided on the internal peripheral side in the thickness direction of the solid oxide electrolyte 10. However, the construction of the cell 1 is not limited to the first embodiment and the anode 11 may be provided on the internal peripheral side in the thickness direction of the solid oxide electrolyte 10. The cathode 12 may be provided on the external peripheral side in the thickness direction of the solid oxide electrolyte 10.

The position and definition of the low temperature region, the intermediate temperature region, and the high temperature region are relatively determined and are not limited within the temperature range indicated in the embodiments. Thus, although the high temperature region T3 is determined equal to or higher than 900° C. and less than 1100° C. in the first embodiment, the range of the temperature may be varied by 100° C. or 50° C. either positively or negatively depending on the kinds of the cell. Although the low temperature region T1 is determined to be equal to or higher than 500° C. and less than 700° C. in the first embodiment, the range of the temperature may be varied by 100° C. or 50° C. either positively or negatively depending on the kinds of the cell. Although the intermediate temperature region T2 is determined to be equal to or higher than 700° C. and less than 900° C., the range of the temperature may be varied by 100° C. or 50° C. either positively or negatively depending on the kinds of the cell.

Although the solid oxide electrolyte 10 is configured cylindrically according to the first embodiment, the solid oxide electrolyte 10 may be formed in cylindrical configuration having the rectangular shape in cross-section. The number of the cell is not limited in the solid oxide fuel cell electrolyte.

According to the third embodiment, the top end region in the longitudinal direction of the solid oxide electrolyte 10C is determined to be the high temperature region T3 and the bottom end region in the longitudinal direction of the solid oxide electrolyte 10C is determined to be the low temperature region T1. The construction of the solid oxide electrolyte is not limited and the top end region in the longitudinal direction of the solid oxide electrolyte 10C may be determined to be the low temperature region and the bottom end region in the longitudinal direction of the solid oxide electrolyte 10C may be determined to be the high temperature region.

According to the fourth embodiment, the top end region in the longitudinal direction of the cell module 19D is determined to be the high temperature region T3 and the bottom end region in the longitudinal direction of the cell module 19D is determined to be the low temperature region T1. However, the construction of the cell module 19D is not limited and the top end region in the longitudinal direction of the tube shaped cell module may be determined to be the low temperature region and the bottom end region in the longitudinal direction of the cell module 19D may be determined to be the high temperature region.

According to the solid oxide fuel cell system, the solid oxide electrolyte is determined to have different compositions on the high temperature region having relatively high operation temperature and the low temperature region having relatively low operation temperature. Thus, the composition achieving the high ion conduction at the high temperature region is adopted at the high temperature region of the solid oxide electrolyte. In addition, the composition achieving the high ion conduction at the low temperature region is adopted at the low temperature region of the solid oxide electrolyte. Accordingly, the favorable power generation is performed both at the high temperature region and at the low temperature region of the solid oxide electrolyte and the power generation efficiency is increased. This allows not maintaining the entire solid oxide electrolyte in the high temperature region to shorten the rising time for starting the solid oxide fuel cell system.

Because it is not necessary to maintain the entire solid oxide electrolyte in the high temperature region, the thermal leakage amount to the outside during the operation of the system can be restrained. Further, by sealing the low temperature region of the solid oxide electrolyte by the sealing portion, the thermal degradation of the sealing portion is restrained and the degree of freedom for selecting the material for the sealing portion can be increased.

Other preferred embodiments, A-U, which are not intended to be limiting unless otherwise specified, are given below.

A. A solid oxide fuel cell system including: a solid oxide electrolyte including an ion conduction; an anode provided on one side of the solid oxide electrolyte; a cathode provided on the other side of the solid oxide electrolyte; a cell including the anode and the cathode; a fuel cell supply passage configured to supply a fuel to the anode of the cell; an oxidant supply passage configured to supply an oxidant to the cathode of the cell; and a cell module including either the single cell or plural cells including different operation temperature depending on portions of the solid oxide electrolyte; wherein the solid oxide electrolyte includes different compositions at a high temperature region having a relatively high operation temperature and a low temperature region having a relatively low operation temperature and power density at the low temperature region is increased.

B. A solid oxide fuel cell system according to embodiment A, further including a heating portion configured to heat the solid oxide electrolyte, the heating portion being provided to generate temperature gradient including the low temperature region and high temperature region in the solid oxide electrolyte included in the cell module; wherein the solid oxide electrolyte includes an electrolyte portion determined to have a graded composition from the low temperature region to the high temperature region and the power density at the low temperature region is increased.

C. A solid oxide fuel cell system according to embodiments A or B, further including a sealing portion configured to seal the solid oxide electrolyte, the sealing portion sealing the low temperature region having the relatively low temperature in the solid oxide electrolyte.

D. A solid oxide fuel cell system according to embodiment C, wherein the sealing portion includes glass system, ceramics system, carbon system, metal system, or cermet system corresponding to a mixture of metal and ceramics.

E. A solid oxide fuel cell system according to embodiments A-C, wherein the solid oxide electrolyte includes any one of the oxide which mainly includes lanthanum (La), strontium (Sr), gallium (Ga), magnesium (Mg), and A element corresponding to at least one of cobalt (Co) and Nickel (Ni), ceria oxide, or zirconia oxide as a base material.

F. A solid oxide fuel cell system according to embodiment E, wherein the solid oxide electrolyte includes a composition region including the oxide which mainly includes lanthanum (La), strontium (Sr), gallium (Ga), magnesium (Mg), and A element corresponding to at least one of cobalt (Co) and Nickel (Ni) and the solid oxide electrolyte includes an electrolyte portion determined that magnesium (Mg) is increased and A element is reduced (including zero mole) by mole ratio as moving to a portion of the composition region having the higher operation temperature.

G. A solid oxide fuel cell system according to embodiment E, wherein the solid oxide electrolyte includes a composition region including the oxide which mainly includes stabilized zirconia including yttria and scandia as a base material at the low temperature region and the intermediate temperature region and the solid oxide electrolyte includes an electrolyte portion determined that yttrium (Y) is relatively increased by mole ratio and scandium (Sc) is relatively reduced as moving to the portion of the composition region having higher operation temperature.

H. A solid oxide fuel cell system according to embodiment E, wherein the solid oxide electrolyte includes the oxide of ceria system which mainly includes cerium (Ce) and B element including one or two kinds of samarium (Sm) and gadolinium (Gd) at the low temperature region and the solid oxide electrolyte includes the oxide of the stabilized zirconia system including as least one of yttria and scandia at the high temperature region as base material.

I. A solid oxide fuel cell system including: a solid oxide electrolyte including an ion conduction; an anode provided on one side of the solid oxide electrolyte; a cathode provided on the other side of the solid oxide electrolyte; a cell including the anode and the cathode; a fuel cell supply passage configured to supply a fuel to the anode of the cell; an oxide supply passage configured to supply an oxide to the cathode of the cell; wherein the solid oxide electrolyte includes different operation temperature depending on the portion.

J. A solid oxide fuel cell system according to embodiment J, wherein the anode includes different anode composition at a high temperature region having a relatively high operation temperature and an anode composition at a low temperature region having a relatively low operation temperature.

K. A solid oxide fuel cell system according to embodiment K, wherein the anode composition includes a graded composition in accordance with a temperature gradient of the operation temperature.

L. A solid oxide fuel cell system according to embodiment J, wherein the cathode includes different cathode composition at a high temperature region having relatively high operation temperature and a cathode composition at a low temperature region having relatively low operation temperature.

M. A solid oxide fuel cell system according to embodiment M, wherein the cathode composition includes a graded composition in accordance with a temperature gradient of the operation temperature.

N. A solid oxide fuel cell system according to embodiment J, further including an inter-connector wherein the inter-connector includes different inter-connector composition at a high temperature region having relatively high operation temperature and an inter-connector composition at a low temperature region having relatively low operation temperature.

O. A solid oxide fuel cell system according to embodiment O, wherein the inter-connector composition includes a graded composition in accordance with a temperature gradient of the operation temperature.

P. A solid oxide fuel cell system according to embodiment J, further including a cell module including plural cells including different operation temperature depending on portions of the solid oxide electrolyte; wherein the solid oxide electrolyte constructing the cell module includes different composition at a high temperature region having relatively high operation temperature and a composition at a low temperature region having relatively low operation temperature.

Q. A solid oxide fuel cell system according to embodiment Q, wherein the cathode composition includes a graded composition in accordance with a temperature gradient of the operation temperature.

R. A solid oxide fuel cell system according to embodiment A, wherein the solid oxide electrolyte includes lanthanum oxide including a composition of La_{0.8}Sr_{0.2}Ga_{0.8}Mg_{0.2-X}A_{X}O_{3-Z} or La_{0.9}Sr_{0.1}Ga_{0.8}Mg_{0.2-X}A_{X}O_{3-Z} including at least one of cobalt (Co), nickel (Ni) or both as A element where Z is varied between zero and 0.2 and X is varied between 0.08 and zero as moving to the position with higher operation temperature.

S. A solid oxide fuel cell system according to embodiment E, wherein the solid oxide electrolyte includes ceria oxide including a composition of Ce_{0.8}B_{0.2}O_{1.9-δ} including at least one of samarium (Sm), gadolinium (Gd) or both as B element where δ is varied between zero and 0.4; and wherein the ceria oxide solid oxide electrolyte is applied to the low temperature region.

T. A solid oxide fuel cell system according to embodiment H, wherein the solid oxide electrolyte includes the stabilized zirconia oxide including a composition of Zr_{0.8}Sc_{0.2-X}Y_{X}O_{1.91-Z} where Z is varied between zero and 0.01 and X is varied between zero and 0.02.

The principles, preferred embodiment and mode of operation of the present invention have been described in the foregoing specification. However, the invention which is intended to be protected is not to be construed as limited to the particular embodiments disclosed. Further, the embodiment described herein is to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A solid oxide fuel cell, comprising:
an anode;
a cathode; and
an ionically conducting solid oxide electrolyte disposed between the anode and the cathode;
wherein the solid oxide electrolyte comprises at least one first region having a relatively high operating temperature and at least one second region having a relatively low operating temperature;
and wherein the composition of the solid oxide electrolyte is different in the first and second regions.

2. The solid oxide fuel cell according to claim 1, further comprising:
at least one fuel supply passage configured to supply at least one fuel to the anode; and
at least one oxidant supply passage configured to supply at least one oxidant to the cathode.

3. The solid oxide fuel cell according to claim 1, further comprising at least one heating portion configured to heat the solid oxide electrolyte and generate a temperature gradient from the first and second regions.

4. The solid oxide fuel cell according to claim 1, wherein the composition varies continuously from the first region to the second region.

5. The solid oxide fuel cell according to claim 1, wherein the composition varies in a stepwise manner from the first region to the second region.

6. The solid oxide fuel cell according to claim 1, further comprising at least one sealing portion configured to seal the second region.

7. The solid oxide fuel cell according to claim 6, wherein the sealing portion is made from one or more materials selected from the group consisting of glass, ceramic, carbon, metal, and cermet.

8. The solid oxide fuel cell according to claim 1, wherein the solid oxide electrolyte comprises, as a base material, at least one oxide selected from the group consisting of:
an oxide comprising lanthanum (La), strontium (Sr), gallium (Ga), magnesium (Mg), and, as A, one or both of cobalt (Co) and nickel (Ni);
ceria oxide;
zirconia oxide;
and a mixture thereof.

9. The solid oxide fuel cell according to claim 1, wherein the solid oxide electrolyte is an oxide comprising lanthanum (La), strontium (Sr), gallium (Ga), magnesium (Mg), and, as A, one or both of cobalt (Co) and nickel (Ni).

10. The solid oxide electrolyte fuel cell according to claim 1, wherein the solid oxide electrolyte is an oxide comprising lanthanum (La), strontium (Sr), gallium (Ga), magnesium (Mg), and, as A, one or both of cobalt (Co) and nickel (Ni),
wherein a magnesium (Mg) concentration is higher in the first region than in the second region,
and wherein an A concentration is higher in the second region than in the first region.

11. The solid oxide electrolyte fuel cell according to claim 1, wherein the solid oxide electrolyte is an oxide comprising lanthanum (La), strontium (Sr), gallium (Ga), magnesium (Mg), and, as A, one or both of cobalt (Co) and nickel (Ni),
wherein a magnesium (Mg) concentration is higher in the first region than in the second region,
and wherein an A concentration is zero in the first region and greater than zero in the second region.

12. The solid oxide fuel cell according to claim 1, wherein the solid oxide electrolyte further comprises at least one intermediate region between the first and second regions, said intermediate region having an intermediate operating temperature between said high and low operating temperatures.

13. The solid oxide fuel cell according to claim 1, wherein the solid oxide electrolyte further comprises at least one intermediate region between the first and second regions, said intermediate region having an intermediate operating temperature between said high and low operating temperatures,
wherein the compositions of the second and intermediate regions comprise, as a base material, a stabilized zirconia oxide comprising yttria and scandia,
wherein the yttrium concentration is higher in the second region than in the first region,
and wherein the scandium concentration is higher in the first region than in the second region.

14. The solid oxide fuel cell according to claim 1, wherein the solid oxide electrolyte comprises:
as a base material of the second region, an oxide comprising cerium (Ce) and, as B, one or both of samarium (Sm) and gadolinium (Gd);
and, as a base material of the first region, a stabilized zirconia oxide comprising yttria and Scandia.

15. The solid oxide fuel cell according to claim 1, wherein the solid oxide electrolyte has the composition La_{0.8}Sr_{0.2}Ga_{0.8}Mg_{0.2-X}A_{X}O_{3-Z} or La_{0.9}Sr_{0.1}Ga_{0.8}Mg_{0.2-X}A_{X}O_{3-Z}
wherein A is one or both of cobalt (Co) and nickel (Ni),
wherein Z is 0-0.2,
and wherein X is 0.08-0.

16. The solid oxide fuel cell according to claim 1, wherein the solid oxide electrolyte has the composition La_{0.8}Sr_{0.2}Ga_{0.8}Mg_{0.2-X}A_{X}O_{3-Z} or La_{0.9}Sr_{0.1}Ga_{0.8}Mg_{0.2-X}A_{X}O_{3-Z}
wherein A is one or both of cobalt (Co) and nickel (Ni),
wherein Z varies from zero to 0.2 moving from the second region to the first region,
and wherein X varies from 0.08 to zero moving from the second region to the first region.

17. The solid oxide fuel cell according to claim 1, wherein the solid oxide electrolyte has the composition of Ce_{0.8}B_{0.2}O_{1.9-δ}
wherein B is one or both of samarium (Sm) and gadolinium (Gd);
and wherein δ is 0-0.4.

18. The solid oxide fuel cell according to claim 1, wherein the solid oxide electrolyte has the composition Ce_{0.8}B_{0.2}O_{1.9-δ}
wherein B is one or both of samarium (Sm) and gadolinium (Gd);
and wherein δ varies from zero to 0.4 moving from the second region to the first region.

19. The solid oxide fuel cell according to claim 1, wherein the solid oxide electrolyte has the composition Zr_{0.8}Sc_{0.2-X}Y_{X}O_{1.9-Z}
where Z is 0-0.4,
and wherein X is 0-0.2.

20. A method for making the solid oxide fuel cell according to claim 1, comprising disposing the solid oxide electrolyte between the anode and the cathode.

21. A fuel cell module, comprising one or more of the solid oxide fuel cells according to claim 1, at least one fuel supply passage configured to supply at least one fuel to the anode;
at least one oxidant supply passage configured to supply at least one oxidant to the cathode; and
at least one heating portion configured to heat the solid oxide electrolyte and generate a temperature gradient from the first and second regions.

22. A method for producing electricity with the solid oxide fuel cell of claim 1, comprising, contacting the anode with a fuel and contacting the cathode with an oxidant.

23. An ionically conducting solid oxide electrolyte, comprising:
at least one first region having a relatively high operation temperature and at least one second region having a relatively low operation temperature;
and wherein the composition of the solid oxide electrolyte is different in the first and second regions.

24. A method for making the solid oxide electrolyte according to claim 23, comprising, varying the composition of of the solid oxide electrolyte between said first and second regions, to form the ionically conducting solid oxide electrolyte.
